(19) United States
(12) Patent Application Publication
(10) Pub. No.: US 2026/0317605 A1
(43) Pub. Date: Oct. 15, 2026

(54) CHEMICAL-MECHANICAL POLISHING COMPOSITION CONTAINING SPHERICAL ALUMINA

(71) Applicant: ENTEGRIS, INC., Billerica, MA (US)

(72) Inventors: P. Chinnathambi Selvaraj, Singapore (SG); Hiroshi Kitamura, Tsu-city (JP)

(21) Appl. No.: 19/643,738

(22) Filed: Apr. 9, 2026

Related U.S. Application Data
(60) Provisional application No. 63/786,523, filed on Apr. 10, 2025.

(51) Int. Cl. C09K 3/14; B24B 37/04; B24B 37/10

(52) U.S. Cl. CPC C09K 3/1463; B24B 37/044; B24B 37/10; C09K 3/1409

(57) ABSTRACT

The invention provides a chemical-mechanical polishing composition comprising: (a) alpha alumina particles with a particle size of greater than 250 nm having an average circularity value of at least 0.6, wherein the circularity value is determined using the formula:

$$Circularity = 4 π ( \frac{area of particle cross se ction}{perimeter of {particle}^{2}} ) ,$$

wherein the area of particle cross section and the perimeter of particle are measured using a binarized electron micrograph, (b) an oxidizing agent, and (c) water, wherein the polishing composition has a pH of about 0 to about 6. The invention also provides a method of chemically-mechanically polishing a substrate using said composition.

### BACKGROUND OF THE INVENTION

In the fabrication of integrated circuits and other electronic devices, conducting, semiconducting, and/or dielectric materials are deposited onto or removed from a substrate surface. As layers of materials are sequentially deposited onto and removed from the substrate, the uppermost surface of the substrate may become non-planar and require planarization. Planarizing a surface, or “polishing” a surface, is a process where material is removed from the surface of the substrate to form a generally even, planar surface. Planarization is useful in removing undesired surface topography and surface defects, such as rough surfaces, agglomerated materials, crystal lattice damage, scratches, and contaminated layers or materials. Planarization also is useful in forming features on a substrate by removing excess deposited material used to fill the features and to provide an even surface for subsequent levels of metallization and processing.

Compositions and methods for planarizing or polishing the surface of a substrate are well known in the art. Chemical-mechanical planarization, or chemical-mechanical polishing (CMP), is a common technique used to planarize substrates. CMP utilizes a chemical composition, known as a CMP composition or more simply as a polishing composition (also referred to as a polishing slurry), for selective removal of material from the substrate. Polishing compositions typically are applied to a substrate by contacting the surface of the substrate with a polishing pad (e.g., polishing cloth or polishing disk) saturated with the polishing composition. The polishing of the substrate typically is further aided by the chemical activity of the polishing composition and/or the mechanical activity of an abrasive suspended in the polishing composition or incorporated into the polishing pad (e.g., fixed abrasive polishing pad).

A polishing composition can be characterized according to its polishing rate (i.e., removal rate) and its planarization efficiency. The polishing rate refers to the rate of removal of a material from the surface of the substrate and is usually expressed in terms of units of length (thickness) per unit of time (e.g., Angstroms (Å) per minute). Planarization efficiency relates to step height reduction versus amount of material removed from the substrate. Specifically, a polishing surface, e.g., a polishing pad, first contacts the “high points” of the surface and must remove material in order to form a planar surface. A process that results in achieving a planar surface with less removal of material is considered to be more efficient than a process requiring removal of more material to achieve planarity.

One particular electronic device of interest is hard disk drives (HDD). In that respect, demand for HDDs with high storage capacity has been significantly increasing, as HDD customer demand has shifted toward larger (i.e., higher diameter) and thinner disks for achieving higher media arial density. Generally, hard disks are made from an alum-based material, which is plated with nickel-phosphorus (NiP). The preparation process for these NiP-plated alum hard disks typically includes (i) grinding of the alum-based plates, which can result in grinding marks, and (ii) NiP plating on the alum-based plates, which can create shallow, circular pits, plating deposited inclusions (PDI), and nodular defects.

Chemical-mechanical polishing (CMP) is typically employed to remove the foregoing defects by utilizing (a) bulk polishing and/or (b) final polishing. Conventional bulk polishing processes in the hard disk industry utilize alumina or an alumina/silica hybrid slurries due to their high removal rates and planarization efficiency of plating defects. However, conventional alumina particles, utilized by these techniques, tend to become embedded in the NiP surface, thereby leading to hard drive failures at thermal asperity. See FIG. 1 for an exemplary embedded alumina particle. The embedded defects contribute to recording errors, lower magnetic properties, and a lower signal to noise ratio (SNR) of the media in perpendicular magnetic recording (PMR) and heat-assisted magnetic recording (HAMR) processes.

Thus, a need remains for compositions and methods for chemical-mechanical polishing to effectively remove materials such as, for example, NiP, at suitable polishing rates without creating surface defects. The invention provides such polishing compositions and methods. These and other advantages of the invention, as well as additional inventive features, will be apparent from the description of the invention provided herein.

### BRIEF SUMMARY OF THE INVENTION

The invention provides a chemical-mechanical polishing composition comprising: (a) alpha alumina particles with a particle size of greater than 250 nm having an average circularity value of at least 0.6, wherein the circularity value is determined using the formula:

$$Circularity = 4 π ( \frac{area of particle cross se ction}{perimeter of {particle}^{2}} ) ,$$

wherein the area of particle cross section and the perimeter of particle are measured using a binarized electron micrograph, (b) an oxidizing agent, and (c) water, wherein the polishing composition has a pH of about 0 to about 6.

The invention further provides a method of chemically-mechanically polishing a substrate comprising: (i) providing a substrate, (ii) providing a polishing pad, (iii) providing a chemical-mechanical polishing composition comprising: (a) alpha alumina particles with a particle size of greater than 250 nm having an average circularity value of at least 0.6, wherein the circularity value is determined using the formula:

$$Circularity = 4 π ( \frac{area of particle cross se ction}{perimeter of {particle}^{2}} ) ,$$

wherein the area of particle cross section and the perimeter of particle are measured using a binarized electron micrograph, (b) an oxidizing agent, and (c) water, wherein the polishing composition has a pH of about 0 to about 6, (iv) contacting the substrate with the polishing pad and the chemical-mechanical polishing composition, and (v) moving the polishing pad and the chemical-mechanical polishing composition relative to the substrate to abrade at least a portion of the substrate to polish the substrate.

### BRIEF DESCRIPTION OF THE DRAWINGS

FIG. 1 is an image showing an embedded defect in a nickel-phosphorus (NiP) surface.

FIGS. 2A and 2B are scanning electron microscope images showing alpha alumina particles with sharp edges at display scales of 5 μm (FIG. 2A) and 1 μm (FIG. 2B).

FIGS. 3A and 3B are scanning electron microscope images showing alpha alumina particles with blunted and smooth surfaces at display scales of 5 μm (FIG. 3A) and 1 μm (FIG. 3B).

FIG. 4 provides scanning electron microscope images (20× magnification) at four different locations of a NiP-plated hard disk that has been polished with alumina particles with sharp edges.

FIG. 5 provides a plot showing the results of an energy-dispersive x-ray (EDX) analysis of the surface of the NiP-plated hard disk imaged in FIG. 4.

FIG. 6 provides scanning electron microscope images (20× magnification) at four different locations of a NiP-plated hard disk that has been polished with alumina particles with blunted and smooth surfaces.

FIG. 7 provides a plot showing the results of an energy-dispersive x-ray (EDX) analysis of the surface of the NiP-plated hard disk imaged in FIG. 6.

### DETAILED DESCRIPTION OF THE INVENTION

The invention provides a chemical-mechanical polishing composition comprising: (a) alpha alumina particles with a particle size of greater than 250 nm having an average circularity value of at least 0.6, wherein the circularity value is determined using the formula:

$$Circularity = 4 π ( \frac{area of particle cross se ction}{perimeter of {particle}^{2}} ) ,$$

wherein the area of particle cross section and the perimeter of particle are measured using a binarized electron micrograph, (b) an oxidizing agent, and (c) water, wherein the polishing composition has a pH of about 0 to about 6.

The chemical-mechanical polishing composition comprises alpha alumina particles. The alpha alumina particles can have any suitable average particle size as long as the alpha alumina particles with a particle size of greater than 250 nm have an average circularity value of at least 0.6, wherein the circularity value is determined using the formula:

$$Circularity = 4 π ( \frac{area of particle cross se ction}{perimeter of {particle}^{2}} ) ,$$

wherein the area of particle cross section and the perimeter of particle are measured using a binarized electron micrograph.

For non-spherical alpha alumina particles, the size of the particle is the diameter of the smallest sphere that encompasses the particle. The particle size of the alpha alumina particles can be measured using any suitable technique, for example, using laser diffraction techniques. Suitable particle size measurement instruments are available from e.g., Malvern Instruments (Malvern, UK).

For example, the alpha alumina particles can have an average particle size of about 50 nm or more, about 100 nm or more, about 150 nm or more, about 200 nm or more, about 250 nm or more, about 300 nm or more, about 350 nm or more, about 400 nm or more, or about 450 nm or more. Alternatively, or in addition, the alpha alumina particles can have an average particle size of about 800 nm or less, about 750 nm or less, about 700 nm or less, about 650 nm or less, about 600 nm or less, about 550 nm or less, about 500 nm or less, or about 450 nm or less. Thus, the alpha alumina particles can have an average particle size bounded by any two of the aforementioned endpoints.

For example, the alpha alumina particles can have an average particle size of about 50 nm to about 800 nm, about 50 nm to about 750 nm, about 50 nm to about 700 nm, about 50 nm to about 650 nm, about 50 nm to about 600 nm, about 50 nm to about 550 nm, about 50 nm to about 500 nm, about 50 nm to about 450 nm, about 100 nm to about 800 nm, about 100 nm to about 750 nm, about 100 nm to about 700 nm, about 100 nm to about 650 nm, about 100 nm to about 600 nm, about 100 nm to about 550 nm, about 100 nm to about 500 nm, about 100 nm to about 450 nm, about 200 nm to about 800 nm, about 200 nm to about 750 nm, about 200 nm to about 700 nm, about 200 nm to about 650 nm, about 200 nm to about 600 nm, about 200 nm to about 550 nm, about 200 nm to about 500 nm, or about 200 nm to about 450 nm.

The area of particle cross section and perimeter of particle squared can be determined by known methods. In this embodiment, particles were selected randomly from a set of images acquired between 20-50 k×magnification and cropped to fill an approximate 1×1 micron field of view (FOV) for measurement of circularity. Segmentation was performed by intensity thresholding of the cropped electron micrographs. Circularity was calculated from the subsequently binarized particle segments by the formula, 4pi ([area]/[perimeter]²), where area and perimeter are measured in pixels. Area herein refers to the cross-sectional area of each particle segment whereas perimeter is the length of the outer particle boundary.

The alpha alumina particles with a particle size of greater than 250 nm have an average circularity value of at least 0.6 (e.g., an average circularity value of at least 0.61, an average circularity value of at least 0.62, an average circularity value of at least 0.63, an average circularity value of at least 0.64, an average circularity value of at least 0.65, an average circularity value of at least 0.66, an average circularity value of at least 0.67, an average circularity value of at least 0.68, an average circularity value of at least 0.69, or an average circularity value of at least 0.7), wherein the circularity value is determined using the formula:

$$Circularity = 4 π ( \frac{area of particle cross se ction}{perimeter of {particle}^{2}} ) ,$$

wherein the area of particle cross section and the perimeter of particle are measured using a binarized electron micrograph. In some embodiments, the alpha alumina particles with a particle size of greater than 250 nm have an average circularity value of 0.6-1.0, for example, an average circularity value of 0.6-0.95, 0.6-0.9, 0.6-0.85, 0.6-0.8, 0.6-0.75, 0.65-1.0, 0.65-0.95, 0.65-0.9, 0.65-0.85, 0.65-0.8, 0.65-0.75, 0.7-1.0, 0.7-0.95, 0.7-0.9, 0.7-0.85, 0.7-0.8, or 0.7-0.75. In certain embodiments, the alpha alumina particles with a particle size of greater than 250 nm have an average circularity value of 0.6-0.85. In preferred embodiments, the alpha alumina particles with a particle size of greater than 250 nm have an average circularity value of 0.65-0.8.

The alpha alumina particles with a particle size of greater than 250 nm can be present in the polishing composition in any suitable amount. The composition comprises at least 2× as many alpha alumina particles with a particle size of greater than 250 nm than alpha alumina particles with a particle size of 250 nm or less. In one embodiment, the composition comprises at least 5× as many alpha alumina particles with a particle size of greater than 250 nm than alpha alumina particles with a particle size of 250 nm or less, for example 9×. The polishing composition can comprise about 5 wt. % or less of the alpha alumina particles with a particle size of greater than 250 nm, for example, about 4 wt. % or less, about 3 wt. % or less, about 2 wt. % or less, about 1 wt. % or less, about 0.9 wt. % or less, about 0.8 wt. % or less, about 0.7 wt. % or less, about 0.6 wt. % or less, or about 0.5 wt. % or less of the alpha alumina particles with a particle size of greater than 250 nm. Alternatively, or in addition, the polishing composition can comprise about 0.001 wt. % or more of the alpha alumina particles with a particle size of greater than 250 nm, for example, about 0.005 wt. % or more, about 0.01 wt. % or more, 0.05 wt. % or more, about 0.1 wt. % or more, about 0.2 wt. % or more, about 0.3 wt. % or more, about 0.4 wt. % or more, about 0.5 wt. % or more, or about 1 wt. % or more of alpha alumina particles with a particle size of greater than 250 nm. Thus, the polishing composition can comprise alpha alumina particles with a particle size of greater than 250 nm in an amount bounded by any two of the aforementioned endpoints, as appropriate.

For example, in some embodiments, the alpha alumina particles with a particle size of greater than 250 nm can be present in the polishing composition in an amount of from about 0.001 wt. % to about 5 wt. % of the polishing composition, e.g., about 0.001 wt. % to about 4 wt. %, about 0.001 wt. % to about 2 wt. %, about 0.001 wt. % to about 1 wt. %, about 0.01 wt. % to about 5 wt. %, about 0.01 wt. % to about 4 wt. %, about 0.01 wt. % to about 2 wt. %, about 0.01 wt. % to about 1 wt. %, about 0.05 wt. % to about 5 wt. %, about 0.05 wt. % to about 4 wt. %, about 0.05 wt. % to about 2 wt. %, about 0.05 wt. % to about 1 wt. %, about 0.1 wt. % to about 5 wt. %, about 0.1 wt. % to about 4 wt. %, about 0.1 wt. % to about 2 wt. %, about 0.1 wt. % to about 1 wt. %, about 0.5 wt. % to about 5 wt. %, about 0.5 wt. % to about 4 wt. %, about 0.5 wt. % to about 2 wt. %, about 0.5 wt. % to about 1 wt. %, about 1 wt. % to about 5 wt. %, about 1 wt. % to about 4 wt. %, or about 1 wt. % to about 2 wt. %. In some embodiments, the polishing composition comprises about 0.01 wt. % to about 5 wt. % of the alpha alumina particles with a particle size of greater than 250 nm. In certain embodiments, the polishing composition comprises about 0.1 wt. % to about 2 wt. % of the alpha alumina particles with a particle size of greater than 250 nm.

In some embodiments, the alpha alumina particles with a particle size of greater than 250 nm have an average particle size of about 300 nm to about 800 nm, for example, about 300 nm to about 750 nm, about 300 nm to about 700 nm, about 300 nm to about 650 nm, about 300 nm to about 600 nm, about 300 nm to about 550 nm, about 400 nm to about 800 nm, about 400 nm to about 750 nm, about 400 nm to about 700 nm, about 400 nm to about 600 nm, about 400 nm to about 600 nm, or about 400 nm to about 550 nm. In certain embodiments, the alpha alumina particles with a particle size of greater than 250 nm have an average particle size of about 400 nm to about 600 nm.

In some embodiments, the polishing composition comprises alpha alumina particles with a particle size of 250 nm or less. The alpha alumina particles with a particle size of 250 nm or less can have any suitable average circularity value and can be present in the polishing composition in any suitable amount. The polishing composition can comprise about 5 wt. % or less of the alpha alumina particles with a particle size of 250 nm or less, for example, about 4 wt. % or less, about 3 wt. % or less, about 2 wt. % or less, about 1 wt. % or less, about 0.9 wt. % or less, about 0.8 wt. % or less, about 0.7 wt. % or less, about 0.6 wt. % or less, or about 0.5 wt. % or less of the alpha alumina particles with a particle size of 250 nm or less. Alternatively, or in addition, the polishing composition can comprise about 0.0001 wt. % or more of the alpha alumina particles with a particle size of 250 nm or less, for example, about 0.001 wt. % or more, about 0.005 wt. % or more, about 0.01 wt. % or more, 0.05 wt. % or more, about 0.1 wt. % or more, about 0.2 wt. % or more, about 0.3 wt. % or more, about 0.4 wt. % or more, about 0.5 wt. % or more, or about 1 wt. % or more of alpha alumina particles with a particle size of 250 nm or less. Thus, the polishing composition can comprise alpha alumina particles with a particle size of 250 nm or less in an amount bounded by any two of the aforementioned endpoints, as appropriate.

For example, in some embodiments, the alpha alumina particles with a particle size of 250 nm or less can be present in the polishing composition in an amount of from about 0.0001 wt. % to about 5 wt. % of the polishing composition, e.g., about 0.0001 wt. % to about 4 wt. %, about 0.0001 wt. % to about 2 wt. %, about 0.0001 wt. % to about 1 wt. %, about 0.001 wt. % to about 5 wt. %, about 0.001 wt. % to about 4 wt. %, about 0.001 wt. % to about 2 wt. %, about 0.001 wt. % to about 1 wt. %, about 0.01 wt. % to about 5 wt. %, about 0.01 wt. % to about 4 wt. %, about 0.01 wt. % to about 2 wt. %, about 0.01 wt. % to about 1 wt. %, about 0.05 wt. % to about 5 wt. %, about 0.05 wt. % to about 4 wt. %, about 0.05 wt. % to about 2 wt. %, about 0.05 wt. % to about 1 wt. %, about 0.1 wt. % to about 5 wt. %, about 0.1 wt. % to about 4 wt. %, about 0.1 wt. % to about 2 wt. %, about 0.1 wt. % to about 1 wt. %, about 0.5 wt. % to about 5 wt. %, about 0.5 wt. % to about 4 wt. %, about 0.5 wt. % to about 2 wt. %, about 0.5 wt. % to about 1 wt. %, about 1 wt. % to about 5 wt. %, about 1 wt. % to about 4 wt. %, or about 1 wt. % to about 2 wt. %.

The polishing composition comprises an oxidizing agent. The oxidizing agent can be any suitable oxidizing agent. Without wishing to be bound by any particular theory, it is believed that the oxidizing agent increases the removal rate of the substrate (e.g., nickel-phosphorous) by oxidizing the substrate surface. Non-limiting examples of suitable oxidizing agents include hydrogen peroxide, a urea hydrogen peroxide, a peroxysulfuric acid (e.g., peroxydisulfuric acid or peroxydisulfuric acid salts such as sodium persulfate), a peroxyacetic acid, a perboric acid, a salt thereof, or a combination thereof. In some embodiments, the oxidizing agent is hydrogen peroxide. In some embodiments, the oxidizing agent is a persulfate salt such as, for example, sodium persulfate.

The polishing composition can contain any suitable amount of the oxidizing agent. The polishing composition can comprise about 0.01 wt. % or more of the oxidizing agent, for example, about 0.05 wt. % or more, about 0.1 wt. % or more, about 0.5 wt. % or more, about 1 wt. % or more, or about 1.5 wt. % or more of the oxidizing agent. Alternatively, or in addition, the polishing composition can comprise about 10 wt. % or less of the oxidizing agent, for example, about 5 wt. % or less, about 2 wt. % or less, or about 1 wt. % or less of the oxidizing agent. Thus, the polishing composition can comprise the oxidizing agent in an amount bounded by any two of the aforementioned endpoints, as appropriate.

For example, the oxidizing agent can be present in the polishing composition in an amount of from about 0.01 wt. % to about 10 wt. % of the polishing composition, e.g., about 0.01 wt. % to about 5 wt. %, about 0.01 wt. % to about 2 wt. %, about 0.01 wt. % to about 1 wt. %, about 0.05 wt. % to about 10 wt. %, 0.05 wt. % to about 5 wt. %, about 0.05 wt. % to about 2 wt. %, about 0.05 wt. % to about 1 wt. %, about 0.1 wt. % to about 10 wt. %, 0.1 wt. % to about 5 wt. %, about 0.1 wt. % to about 2 wt. %, about 0.1 wt. % to about 1 wt. %, about 0.5 wt. % to about 10 wt. %, 0.5 wt. % to about 5 wt. %, about 0.5 wt. % to about 2 wt. %, about 0.5 wt. % to about 1 wt. %, about 1 wt. % to about 10 wt. %, 1 wt. % to about 5 wt. %, or about 1 wt. % to about 2 wt. %.

In some embodiments, the polishing composition further comprises silica particles. Silica particles (e.g., wet-process silica particles) can be prepared by various methods, some examples of which are commercially used and known. Useful silica particles (e.g., wet-process silica particles) include precipitated and/or condensation-polymerized silica, which may be prepared using known methods, such as by methods referred to as the “sol gel” method or by silicate ion-exchange. Condensation-polymerized silica particles are often prepared by condensing Si(OH)₄ to form substantially spherical (e.g., spherical, ovular, or oblong) particles. The precursor Si(OH)₄ may be obtained, for example, by hydrolysis of high purity alkoxysilanes, or by acidification of aqueous silicate solutions. U.S. Pat. No. 5,230,833 describes a method for preparing colloidal silica particles in solution.

In some embodiments, the silica particles are colloidal silica. As known to one of ordinary skill in the art, colloidal silicas are suspensions of fine amorphous, nonporous and typically spherical particles in a liquid phase. The colloidal silica can take the form of condensation-polymerized or precipitated silica particles. In some embodiments, the silica is in the form of wet-process type silica particles.

The particles, e.g., colloidal silica, can have any suitable average size (i.e., average particle diameter). For non-spherical silica particles, the size of the particle is the diameter of the smallest sphere that encompasses the particle. The particle size of the silica particles can be measured using any suitable technique, for example, using laser diffraction techniques. Suitable particle size measurement instruments are available from e.g., Malvern Instruments (Malvern, UK).

Accordingly, the silica particles can have an average particle size of about 10 nm or more, for example, about 15 nm or more, about 20 nm or more, about 25 nm or more, about 30 nm or more, about 35 nm or more, about 40 nm or more, about 45 nm or more, about 50 nm or more, about 60 nm or more, about 70 nm or more, about 80 nm or more, about 90 nm or more, or about 100 nm or more. Alternatively, or in addition, the silica particles can have an average particle size of about 200 nm or less, for example, about 175 nm or less, about 150 nm or less, about 125 nm or less, about 110 nm or less, about 100 nm or less, about 90 nm or less, about 80 nm or less, about 75 nm or less, about 60 nm or less, about 50 nm or less, or about 40 nm or less. Thus, the silica particles can have an average particle size bounded by any two of the aforementioned endpoints.

For example, the silica particles can have an average particle size of about 10 nm to about 200 nm, about 20 nm to about 200 nm, about 20 nm to about 175 nm, about 20 nm to about 150 nm, about 20 nm to about 125 nm, about 20 nm to about 110 nm, about 20 nm to about 100 nm, about 25 nm to about 125 nm, about 25 nm to about 110 nm, about 25 nm to about 100 nm, about 30 nm to about 100 nm, about 30 nm to about 75 nm, about 30 nm to about 40 nm, about 40 nm to about 100 nm, about 40 nm to about 75 nm, about 40 nm to about 60 nm, about 50 nm to about 150 nm, about 50 nm to about 125 nm, about 50 nm to about 110 nm, about 50 nm to about 100 nm, about 80 nm to about 150 nm, about 80 nm to about 125 nm, about 80 nm to about 110 nm, about 80 nm to about 100 nm, about 90 nm to about 150 nm, about 90 nm to about 125 nm, about 90 nm to about 110 nm, about 90 nm to about 100 nm, about 100 nm to about 150 nm, or about 100 nm to about 125 nm. In some embodiments, the silica particles have an average particle size of about 20 nm to about 150 nm. In certain embodiments, the silica particles have an average particle size of about 80 nm to about 125 nm.

The silica particles preferably are colloidally stable in the polishing composition. The term colloid refers to the suspension of particles in the liquid carrier (e.g., water). Colloidal stability refers to the maintenance of that suspension through time. In the context of this invention, an abrasive is considered colloidally stable if, when the abrasive is placed into a 100 mL graduated cylinder and allowed to stand unagitated for a time of 2 hours, the difference between the concentration of particles in the bottom 50 mL of the graduated cylinder ([B] in terms of g/mL) and the concentration of particles in the top 50 mL of the graduated cylinder ([T] in terms of g/mL) divided by the initial concentration of particles in the abrasive composition ([C] in terms of g/mL) is less than or equal to 0.5 (i.e., {[B]-[T]}/[C]≤0.5). More preferably, the value of [B]-[T]/[C] is less than or equal to 0.3, and most preferably is less than or equal to 0.1.

The silica particles can be present in the polishing composition in any suitable amount. The polishing composition can comprise about 10 wt. % or less of the silica particles, for example, about 9 wt. % or less, about 8 wt. % or less, about 7 wt. % or less, about 6 wt. % or less, about 5 wt. % or less, about 4 wt. % or less, about 3 wt. % or less, about 2 wt. % or less, about 1 wt. % or less, about 0.9 wt. % or less, about 0.8 wt. % or less, about 0.7 wt. % or less, about 0.6 wt. % or less, or about 0.5 wt. % or less of the silica particles. Alternatively, or in addition, the polishing composition can comprise about 0.001 wt. % or more of the silica particles, for example, about 0.005 wt. % or more, about 0.01 wt. % or more, 0.05 wt. % or more, about 0.1 wt. % or more, about 0.2 wt. % or more, about 0.3 wt. % or more, about 0.4 wt. % or more, about 0.5 wt. % or more, or about 1 wt. % or more of the silica particles. Thus, the polishing composition can comprise silica particles in an amount bounded by any two of the aforementioned endpoints, as appropriate.

For example, in some embodiments, the silica particles can be present in the polishing composition in an amount of from about 0.001 wt. % to about 10 wt. % of the polishing composition, e.g., about 0.001 wt. % to about 8 wt. %, about 0.001 wt. % to about 6 wt. %, about 0.001 wt. % to about 5 wt. %, about 0.001 wt. % to about 4 wt. %, about 0.001 wt. % to about 2 wt. %, about 0.001 wt. % to about 1 wt. %, about 0.01 wt. % to about 10 wt. %, about 0.01 wt. % to about 8 wt. %, about 0.01 wt. % to about 6 wt. %, about 0.01 wt. % to about 5 wt. %, about 0.01 wt. % to about 4 wt. %, about 0.01 wt. % to about 2 wt. %, about 0.01 wt. % to about 1 wt. %, about 0.05 wt. % to about 10 wt. %, about 0.05 wt. % to about 8 wt. %, about 0.05 wt. % to about 6 wt. %, about 0.05 wt. % to about 5 wt. %, about 0.05 wt. % to about 4 wt. %, about 0.05 wt. % to about 2 wt. %, about 0.05 wt. % to about 1 wt. %, about 0.1 wt. % to about 10 wt. %, about 0.1 wt. % to about 8 wt. %, about 0.1 wt. % to about 6 wt. %, about 0.1 wt. % to about 5 wt. %, about 0.1 wt. % to about 4 wt. %, about 0.1 wt. % to about 2 wt. %, about 0.1 wt. % to about 1 wt. %, about 0.5 wt. % to about 10 wt. %, about 0.5 wt. % to about 8 wt. %, about 0.5 wt. % to about 5 wt. %, about 0.5 wt. % to about 4 wt. %, about 0.5 wt. % to about 2 wt. %, about 0.5 wt. % to about 1 wt. %, about 1 wt. % to about 10 wt. %, about 1 wt. % to about 8 wt. %, about 1 wt. % to about 6 wt. %, about 1 wt. % to about 5 wt. %, about 1 wt. % to about 4 wt. %, or about 1 wt. % to about 2 wt. %. In some embodiments, the polishing composition comprises about 0.01 wt. % to about 5 wt. % of the silica particles. In certain embodiments, the polishing composition comprises about 0.1 wt. % to about 2 wt. % of the silica particles.

In some embodiments, the composition further comprises fumed alumina (i.e., fumed alumina particles). Fumed alumina is an amorphous form of aluminum oxide. Fumed alumina has an aggregate structure in which approximately spherical primary particles are associated into chain-like aggregates of primary particles. The primary particles are bonded together by covalent bonds and electrostatic interactions and typically are resistant to degradation by, e.g., mechanical energy inputs such as high shear mixing. Multiple fumed alumina aggregates can be more loosely associated in the form of agglomerates. Agglomerates are more easily broken up into their component aggregates. The particle size of the fumed alumina refers to the diameter of the smallest sphere that encloses the aggregate of primary particles (rather than individual primary particles or the agglomerates of multiple aggregates). The particle size of the fumed alumina particles can be measured using any suitable technique, for example, using laser diffraction techniques. Suitable particle size measurement instruments are available from e.g., Malvern Instruments (Malvern, UK)

The fumed alumina particles can have any suitable average particle size. For example, the fumed alumina particles can have an average particle size of about 30 nm or more, about 40 nm or more, about 50 nm or more, about 60 nm or more, about 70 nm or more, about 80 nm or more, about 90 nm or more, or about 100 nm or more. Alternatively, or in addition, the fumed alumina particles can have an average particle size of about 250 nm or less, 225 nm or less, about 200 nm or less, about 175 nm or less, or about 150 nm or less. Thus, the fumed alumina particles can have an average particle size bounded by any two of the aforementioned endpoints.

Thus, the fumed alumina particles can have an average particle size of about 30 nm to about 250 nm, about 30 nm to about 225 nm, about 30 nm to about 200 nm, about 30 nm to about 175 nm, about 30 nm to about 150 nm, about 40 nm to about 250 nm, about 40 nm to about 225 nm, about 40 nm to about 200 nm, about 40 nm to about 175 nm, about 40 nm to about 150 nm, about 50 nm to about 250 nm, about 50 nm to about 225 nm, about 50 nm to about 200 nm, about 50 nm to about 175 nm, about 50 nm to about 150 nm, about 60 nm to about 250 nm, about 60 nm to about 225 nm, about 60 nm to about 200 nm, about 60 nm to about 175 nm, about 60 nm to about 150 nm, about 70 nm to about 250 nm, about 70 nm to about 225 nm, about 70 nm to about 200 nm, about 70 nm to about 175 nm, about 70 nm to about 150 nm, about 80 nm to about 250 nm, about 80 nm to about 225 nm, about 80 nm to about 200 nm, about 80 nm to about 175 nm, about 80 nm to about 150 nm, about 90 nm to about 250 nm, about 90 nm to about 225 nm, about 90 nm to about 200 nm, about 90 nm to about 175 nm, about 90 nm to about 150 nm, about 100 nm to about 250 nm, about 100 nm to about 225 nm, about 100 nm to about 200 nm, about 100 nm to about 175 nm, or about 100 nm to about 150 nm. In some embodiments, the fumed alumina particles have an average particle size of about 50 nm to about 150 nm.

The polishing composition can comprise any suitable amount of the fumed alumina particles. For example, the polishing composition can comprise about 5 wt. % or less of the fumed alumina particles, for example, about 4 wt. % or less, about 3 wt. % or less, about 2 wt. % or less, about 1 wt. % or less, about 0.9 wt. % or less, about 0.8 wt. % or less, about 0.7 wt. % or less, about 0.6 wt. % or less, or about 0.5 wt. % or less of the fumed alumina particles. Alternatively, or in addition, the polishing composition can comprise about 0.001 wt. % or more of the fumed alumina particles, for example, about 0.005 wt. % or more, about 0.01 wt. % or more, 0.05 wt. % or more, about 0.1 wt. % or more, about 0.2 wt. % or more, about 0.3 wt. % or more, about 0.4 wt. % or more, about 0.5 wt. % or more, or about 1 wt. % or more of the fumed alumina particles. Thus, the polishing composition can comprise fumed alumina particles in an amount bounded by any two of the aforementioned endpoints, as appropriate.

For example, in some embodiments, the fumed alumina particles can be present in the polishing composition in an amount of from about 0.001 wt. % to about 5 wt. % of the polishing composition, e.g., about 0.001 wt. % to about 4 wt. %, about 0.001 wt. % to about 2 wt. %, about 0.001 wt. % to about 1 wt. %, about 0.01 wt. % to about 5 wt. %, about 0.01 wt. % to about 4 wt. %, about 0.01 wt. % to about 2 wt. %, about 0.01 wt. % to about 1 wt. %, about 0.05 wt. % to about 5 wt. %, about 0.05 wt. % to about 4 wt. %, about 0.05 wt. % to about 2 wt. %, about 0.05 wt. % to about 1 wt. %, about 0.1 wt. % to about 5 wt. %, about 0.1 wt. % to about 4 wt. %, about 0.1 wt. % to about 2 wt. %, about 0.1 wt. % to about 1 wt. %, about 0.5 wt. % to about 5 wt. %, about 0.5 wt. % to about 4 wt. %, about 0.5 wt. % to about 2 wt. %, about 0.5 wt. % to about 1 wt. %, about 1 wt. % to about 5 wt. %, about 1 wt. % to about 4 wt. %, or about 1 wt. % to about 2 wt. %. In some embodiments, the polishing composition comprises about 0.1 wt. % to about 1 wt. % of the fumed alumina particles.

In some embodiments, the chemical-mechanical polishing composition further comprises a surfactant. The surfactant can be any suitable surfactant, e.g., a non-ionic surfactant, a cationic surfactant, an anionic surfactant, or an amphoteric surfactant. In certain embodiments, the surfactant is a non-ionic surfactant. Suitable nonionic surfactants include copolymer surfactants comprising siloxane units, ethylene oxide units, and/or propylene oxide units which can have a linear, pendant, or trisiloxane structure. Non-limiting examples of suitable nonionic surfactants include alkylphenol ethoxylates (e.g., nonylphenol ethoxylates), alcohol ethoxylates, siloxane ethoxylates, polyalkyl phosphate esters (e.g., P(O)((OR)ₙOR)₃ where each instance of R independently is a C₁₋₄ alkyl group and each instance of n independently is an integer from 2 to 1000), and the like. Preferably, the nonionic surfactant includes nonylphenol ethoxylates such as the Tergitol NP series available from Dow Corning (Midland, MI) and ethylene oxide/propylene oxide copolymers such as the Silwet series available from Hexion Inc. (Columbus, OH).

The surfactant can be present in the polishing composition in any suitable amount. The polishing composition can comprise about 10 wt. % or less of the surfactant, for example, about 5 wt. % or less, about 4 wt. % or less, about 3 wt. % or less, about 2 wt. % or less, about 1.5 wt. % or less, about 1 wt. % or less, or about 0.5 wt. % or less of the surfactant. Alternatively, or in addition, the polishing composition can comprise about 0.01 wt. % or more of the surfactant, for example, about 0.05 wt. % or more, about 0.1 wt. % or more, or about 0.5 wt. % or more of the surfactant. Thus, the polishing composition can comprise the surfactant in an amount bounded by any two of the aforementioned endpoints, as appropriate.

For example, in some embodiments, the surfactant can be present in the polishing composition in an amount of from about 0.01 wt. % to about 10 wt. % of the polishing composition, e.g., about 0.01 wt. % to about 5 wt. %, about 0.01 wt. % to about 4 wt. %, about 0.01 wt. % to about 3 wt. %, about 0.01 wt. % to about 2 wt. %, about 0.01 wt. % to about 1.5 wt. %, about 0.01 wt. % to about 1 wt. %, about 0.01 wt. % to about 0.5 wt. %, about 0.05 wt. % to about 10 wt. %, about 0.05 wt. % to about 5 wt. %, about 0.05 wt. % to about 4 wt. %, about 0.05 wt. % to about 3 wt. %, about 0.05 wt. % to about 2 wt. %, about 0.05 wt. % to about 1.5 wt. %, about 0.05 wt. % to about 1 wt. %, about 0.05 wt. % to about 0.5 wt. %, about 0.1 wt. % to about 10 wt. %, about 0.1 wt. % to about 5 wt. %, about 0.1 wt. % to about 4 wt. %, about 0.1 wt. % to about 3 wt. %, about 0.1 wt. % to about 2 wt. %, about 0.1 wt. % to about 1.5 wt. %, about 0.1 wt. % to about 1 wt. %, about 0.1 wt. % to about 0.5 wt. %, about 0.5 wt. % to about 10 wt. %, about 0.5 wt. % to about 5 wt. %, about 0.5 wt. % to about 4 wt. %, about 0.5 wt. % to about 3 wt. %, about 0.5 wt. % to about 2 wt. %, about 0.5 wt. % to about 1.5 wt. %, or about 0.5 wt. % to about 1 wt. %. In some embodiments, the polishing composition comprises about 0.01 wt. % to about 10 wt. % of the surfactant. In certain embodiments, the polishing composition comprises about 0.5 wt. % to about 5 wt. % of the surfactant.

In some embodiments, the chemical-mechanical polishing composition comprises a buffering agent. The buffering agent preferably possesses an acceptable buffering capacity at the desired pH of the polishing composition. The buffering agent typically includes one or more acids and one or more salts of the acid in relative amounts sufficient to establish the pH of the chemical-mechanical polishing composition at a desired pH value (i.e., a pH of about 0 to about 6), and to maintain that pH within an acceptable range above and below the desired pH during the chemical-mechanical polishing process. For example, the buffering agent can comprise an organic acid (e.g., a carboxylic acid, a phosphonic acid, or the like) or an inorganic acid (e.g., a phosphoric acid or the like) capable of providing a suitable buffering capacity at a desired acidic pH value. In some embodiments, the organic acid comprises a carboxylic acid, a phosphonic acid, or a combination thereof. Non-limiting examples of suitable carboxylic acids include monocarboxylic acids (e.g., acetic acid, benzoic acid, phenylacetic acid, 1-naphthoic acid, 2-naphthoic acid, glycolic acid, formic acid, lactic acid, mandelic acid, and the like) and polycarboxylic acids (e.g., oxalic acid, malonic acid, succinic acid, adipic acid, tartaric acid, citric acid, maleic acid, fumaric acid, aspartic acid, glutamic acid, phthalic acid, isophthalic acid, terephthalic acid, 1,2,3,4-butanetetracarboxylic acid, itaconic acid, and the like), as well as amino acids (e.g., glycine, proline, asparagine, glutamine, glutamic acid, aspartic acid, phenylalanine, alanine, beta-alanine, and the like). Non-limiting examples of suitable organic phosphonic acids include, DEQUEST™ 2060 (i.e., diethylene triamine penta(methylene-phosphonic acid)), DEQUEST™ 7000 (i.e., 2-phosphonobutane-1,2,4-tricarboxylic acid), and DEQUEST™ 2010 (i.e., hydroxyethylidene-1,1-diphosphonic acid), all of which are available from Solutia, Inc., as well as phosphonoacetic acid, iminodi(methylphosphonic acid), and the like. In some embodiments, the buffering agent comprises an organic acid. In certain embodiments, the buffering agent comprises an amino acid. In preferred embodiments, the buffering agent comprises glycine.

The buffering agent can be present in the polishing composition in any suitable amount. The polishing composition can comprise about 5 wt. % or less of the buffering agent, for example, about 4 wt. % or less, about 3 wt. % or less, about 2 wt. % or less, about 1.5 wt. % or less, about 1 wt. % or less, or about 0.5 wt. % or less of the buffering agent. Alternatively, or in addition, the polishing composition can comprise about 0.001 wt. % or more of the buffering agent, for example, about 0.005 wt. % or more, about 0.01 wt. % or more, about 0.05 wt. % or more, about 0.1 wt. % or more, or 0.5 wt. % or more of the buffering agent. Thus, the polishing composition can comprise the buffering agent in an amount bounded by any two of the aforementioned endpoints, as appropriate.

For example, in some embodiments, the buffering agent can be present in the polishing composition in an amount of from about 0.001 wt. % to about 5 wt. % of the polishing composition, e.g., about 0.001 wt. % to about 4 wt. %, about 0.001 wt. % to about 3 wt. %, about 0.001 wt. % to about 2 wt. %, about 0.001 wt. % to about 1.5 wt. %, about 0.001 wt. % to about 1 wt. %, about 0.001 wt. % to about 0.5 wt. %, about 0.005 wt. % to about 5 wt. %, about 0.005 wt. % to about 4 wt. %, about 0.005 wt. % to about 3 wt. %, about 0.005 wt. % to about 2 wt. %, about 0.005 wt. % to about 1.5 wt. %, about 0.005 wt. % to about 1 wt. %, about 0.005 wt. % to about 0.5 wt. %, about 0.01 wt. % to about 5 wt. %, about 0.01 wt. % to about 4 wt. %, about 0.01 wt. % to about 3 wt. %, about 0.01 wt. % to about 2 wt. %, about 0.01 wt. % to about 1.5 wt. %, about 0.01 wt. % to about 1 wt. %, about 0.01 wt. % to about 0.5 wt. %, about 0.05 wt. % to about 5 wt. %, about 0.05 wt. % to about 4 wt. %, about 0.05 wt. % to about 3 wt. %, about 0.05 wt. % to about 2 wt. %, about 0.05 wt. % to about 1.5 wt. %, about 0.05 wt. % to about 1 wt. %, about 0.05 wt. % to about 0.5 wt. %, about 0.1 wt. % to about 5 wt. %, about 0.1 wt. % to about 4 wt. %, about 0.1 wt. % to about 3 wt. %, about 0.1 wt. % to about 2 wt. %, about 0.1 wt. % to about 1.5 wt. %, about 0.1 wt. % to about 1 wt. %, about 0.1 wt. % to about 0.5 wt. %, about 0.5 wt. % to about 5 wt. %, about 0.5 wt. % to about 4 wt. %, about 0.5 wt. % to about 3 wt. %, about 0.5 wt. % to about 2 wt. %, about 0.5 wt. % to about 1.5 wt. %, or about 0.5 wt. % to about 1 wt. %. In some embodiments, the polishing composition comprises about 0.001 wt. % to about 2 wt. % of the buffering agent. In certain embodiments, the polishing composition comprises about 0.001 wt. % to about 0.5 wt. % of the buffering agent.

The chemical-mechanical polishing composition comprises water. The water can be any suitable water including, for example, deionized water or distilled water. In some embodiments, the chemical-mechanical polishing composition can further comprise one or more organic solvents in combination with the water. For example, the polishing composition can further comprise a hydroxylic solvent such as methanol or ethanol, a ketonic solvent, an amide solvent, a sulfoxide solvent, and the like. In certain embodiments, the chemical-mechanical polishing composition comprises pure water.

The chemical-mechanical polishing composition has a pH of about 0 to about 6 at the point-of-use. Thus, the chemical-mechanical polishing composition can have a pH of about 0 or more, e.g., about 0.5 or more, about 1 or more, about 1.5 or more, about 2 or more, about 2.5 or more, or about 3 or more. Alternatively, or in addition, the chemical-mechanical polishing composition can have a pH of about 6 or less, e.g., about 5.5 or less, about 5 or less, about 4.5 or less, about 4 or less, about 3.8 or less, about 3.6 or less, about 3.4 or less, about 3.2 or less, or about 3 or less. Thus, the chemical-mechanical polishing composition can have a pH bounded by any two of the aforementioned endpoints. For example the chemical-mechanical polishing composition can have a pH of about 0 to about 5.5, e.g., about 0 to about 5, about 0 to about 4.5, about 0 to about 4, about 0 to about 3.8, about 0 to about 3.6, about 0 to about 3.4, about 0 to about 3.2, about 0 to about 3, about 0.5 to about 6, about 0.5 to about 5.5, e.g., about 0.5 to about 5, about 0.5 to about 4.5, about 0.5 to about 4, about 0.5 to about 3.8, about 0.5 to about 3.6, about 0.5 to about 3.4, about 0.5 to about 3.2, about 0.5 to about 3, about 1 to about 6, about 1 to about 5.5, e.g., about 1 to about 5, about 1 to about 4.5, about 1 to about 4, about 1 to about 3.8, about 1 to about 3.6, about 1 to about 3.4, about 1 to about 3.2, or about 1 to about 3 at the point-of-use. In some embodiments, the polishing composition has a pH of about 0 to about 3. In certain embodiments, the polishing composition has a pH of about 1 to about 3.

The chemical-mechanical polishing composition can comprise one or more compounds capable of adjusting (i.e., that adjust) the pH of the polishing composition (i.e., pH adjusting compounds). The pH of the polishing composition can be adjusted using any suitable compound capable of adjusting the pH of the polishing composition. The pH adjusting compound desirably is water-soluble and compatible with the other components of the polishing composition. Non-limiting examples of suitable acids for adjusting the pH of the polishing composition include nitric acid, sulfuric acid, phosphoric acid, and organic acids such as formic acid and acetic acid. Non-limiting examples of suitable bases for adjusting the pH of the polishing composition include sodium hydroxide, potassium hydroxide, and ammonium hydroxide. In some embodiments, the buffering agent is sufficient to adjust the pH of the polishing composition. In some embodiments, the pH of the polishing composition is adjusted with an inorganic acid such as, for example, nitric acid, sulfuric acid, or phosphoric acid.

In some embodiments, the chemical-mechanical polishing composition further comprises one or more additives such as, for example, conditioners, acids (e.g., sulfonic acids), complexing agents (e.g., anionic polymeric complexing agents), chelating agents, biocides, scale inhibitors, dispersants, and/or conductivity adjustors.

In some embodiments, the chemical-mechanical polishing composition further comprises a biocide. A biocide, when present, can be any suitable biocide and can be present in the polishing composition in any suitable amount. For example, the biocide can be an isothiazolinone-based biocide such as Kordek MLX™ (DuPont, Wilmington, DE). In certain embodiments, the biocide is 5-chloro-2-methyl-4-isothiazolin-3-one, 2-methyl-4-isothiazolin-3-one, benzisothiazolinone, 1,2-benzisothiazol-3 [2H]-one, methylisothiazolinone, methylchloroisothiazolinone, or a combination thereof. The biocide can be present in the polishing composition at a concentration of about 1 ppm to about 750 ppm, preferably about 10 ppm to about 200 ppm. In some embodiments, the biocide is methylisothiazolinone or methylchloroisothiazolinone.

In some embodiments, the chemical-mechanical polishing composition comprises (a) alpha alumina particles with a particle size of greater than 250 nm having an average circularity value of at least 0.6, wherein the circularity value is determined using the formula:

$$Circularity = 4 π ( \frac{area of particle cross se ction}{perimeter of {particle}^{2}} ) ,$$

wherein the area of particle cross section and the perimeter of particle are measured using a binarized electron micrograph, (b) alpha alumina particles with a particle size of 250 nm or lower, (c) an oxidizing agent, and (d) water, wherein the polishing composition has a pH of about 0 to about 6.

In some embodiments, the chemical-mechanical polishing composition comprises: (a) alpha alumina particles with a particle size of greater than 250 nm having an average circularity value of at least 0.6, wherein the circularity value is determined using the formula:

$$Circularity = 4 π ( \frac{area of particle cross se ction}{perimeter of {particle}^{2}} ) ,$$

wherein the area of particle cross section and the perimeter of particle are measured using a binarized electron micrograph, (b) alpha alumina particles with a particle size of 250 nm or lower, (c) silica particles, (d) an oxidizing agent, and (e) water, wherein the polishing composition has a pH of about 0 to about 6.

In some embodiments, the chemical-mechanical polishing composition comprises: (a) alpha alumina particles with a particle size of greater than 250 nm having an average circularity value of at least 0.6, wherein the circularity value is determined using the formula:

$$Circularity = 4 π ( \frac{area of particle cross se ction}{perimeter of {particle}^{2}} ) ,$$

wherein the area of particle cross section and the perimeter of particle are measured using a binarized electron micrograph, (b) alpha alumina particles with a particle size of 250 nm or lower, (c) fumed alumina particles, (d) silica particles, (e) an oxidizing agent, and (f) water, wherein the polishing composition has a pH of about 0 to about 6.

In some embodiments, the chemical-mechanical polishing composition comprises: (a) alpha alumina particles with a particle size of greater than 250 nm having an average circularity value of at least 0.6, wherein the circularity value is determined using the formula:

$$Circularity = 4 π ( \frac{area of particle cross section}{perimeter of {particle}^{2}} ) ,$$

wherein the area of particle cross section and the perimeter of particle are measured using a binarized electron micrograph, (b) alpha alumina particles with a particle size of 250 nm or lower, (c) a peroxysulfuric acid or a salt thereof, and (d) water, wherein the polishing composition has a pH of about 0 to about 6.

In some embodiments, the chemical-mechanical polishing composition comprises: (a) alpha alumina particles with a particle size of greater than 250 nm having an average circularity value of at least 0.6, wherein the circularity value is determined using the formula:

$$Circularity = 4 π ( \frac{area of particle cross section}{perimeter of {particle}^{2}} ) ,$$

wherein the area of particle cross section and the perimeter of particle are measured using a binarized electron micrograph, (b) alpha alumina particles with a particle size of 250 nm or lower, (c) silica particles, (d) a peroxysulfuric acid or a salt thereof, and (e) water, wherein the polishing composition has a pH of about 0 to about 6.

In some embodiments, the chemical-mechanical polishing composition comprises: (a) alpha alumina particles with a particle size of greater than 250 nm having an average circularity value of at least 0.6, wherein the circularity value is determined using the formula:

$$Circularity = 4 π ( \frac{area of particle cross section}{perimeter of {particle}^{2}} ) ,$$

wherein the area of particle cross section and the perimeter of particle are measured using a binarized electron micrograph, (b) alpha alumina particles with a particle size of 250 nm or lower, (c) fumed alumina particles, (d) silica particles, (e) a peroxysulfuric acid or a salt thereof, and (f) water, wherein the polishing composition has a pH of about 0 to about 6.

The chemical-mechanical polishing composition can be produced by any suitable technique, many of which are known to those skilled in the art. The polishing composition can be prepared in a batch or continuous process. Generally, the polishing composition is prepared by combining the components of the polishing composition in any order. The term “component” as used herein includes individual ingredients (e.g., alpha alumina particles, fumed alumina particles, silica particles, oxidizing agent, optional buffering agent, optional biocide, and/or any other optional additive, etc.) as well as any combination of ingredients (e.g., alpha alumina particles, fumed alumina particles, silica particles, oxidizing agent, optional buffering agent, optional biocide, and/or any other optional additive, etc.).

For example, the polishing composition can be prepared by (i) providing all or a portion of the liquid carrier, (ii) dispersing the alpha alumina particles, fumed alumina particles, silica particles, oxidizing agent, optional buffering agent, optional biocide, and/or any other optional additive, etc., using any suitable means for preparing such a dispersion, (iii) adjusting the pH of the dispersion as appropriate, and (iv) optionally adding suitable amounts of any other optional components and/or additives to the mixture.

Alternatively, the polishing composition can be prepared by (i) providing one or more components (e.g., fumed alumina particles, silica particles, oxidizing agent, optional buffering agent, optional biocide, and/or any other optional additive, etc.) in an alpha alumina particle slurry, (ii) providing one or more components (e.g., fumed alumina particles, silica particles, oxidizing agent, optional buffering agent, optional biocide, and/or any other optional additive, etc.) in an additive solution, (iii) combining the alpha alumina particle slurry and the additive solution to form a mixture, (iv) optionally adding suitable amounts of any other optional additives to the mixture, and (v) adjusting the pH of the mixture as appropriate.

The polishing composition can be supplied as a one-package system comprising alpha alumina particles, fumed alumina particles, silica particles, oxidizing agent, optional buffering agent, optional biocide, and/or any other optional additive, and water. Alternatively, the polishing composition of the invention can be supplied as a two-package system comprising an alpha alumina particle slurry in a first package and an additive solution in a second package, wherein the alpha alumina particle slurry consists essentially of, or consists of, alpha alumina particles and water, and wherein the additive solution consists essentially of, or consists of, alpha alumina particles, fumed alumina particles, silica particles, oxidizing agent, optional buffering agent, optional biocide, and/or any other optional additive. The two-package system allows for the adjustment of polishing composition characteristics by changing the blending ratio of the two packages, i.e., the alpha alumina particle slurry and the additive solution.

Various methods can be employed to utilize such a two-package polishing system. For example, the alpha alumina particle slurry and additive solution can be delivered to the polishing table by different pipes that are joined and connected at the outlet of supply piping. The alpha alumina particle slurry and additive solution can be mixed shortly or immediately before polishing, or can be supplied simultaneously on the polishing table. Furthermore, when mixing the two packages, deionized water can be added, as desired, to adjust the polishing composition and resulting substrate polishing characteristics.

Similarly, a three-, four-, or more package system can be utilized in connection with the invention, wherein each of multiple containers contains different components of the inventive chemical-mechanical polishing composition, one or more optional components, and/or one or more of the same components in different concentrations.

In order to mix components contained in two or more storage devices to produce the polishing composition at or near the point-of-use, the storage devices typically are provided with one or more flow lines leading from each storage device to the point-of-use of the polishing composition (e.g., the platen, the polishing pad, or the substrate surface). As utilized herein, the term “point-of-use” refers to the point at which the polishing composition is applied to the substrate surface (e.g., the polishing pad or the substrate surface itself). By the term “flow line” is meant a path of flow from an individual storage container to the point-of-use of the component stored therein. The flow lines can each lead directly to the point-of-use, or two or more of the flow lines can be combined at any point into a single flow line that leads to the point-of-use. Furthermore, any of the flow lines (e.g., the individual flow lines or a combined flow line) can first lead to one or more other devices (e.g., pumping device, measuring device, mixing device, etc.) prior to reaching the point-of-use of the component(s).

The components of the polishing composition can be delivered to the point-of-use independently (e.g., the components are delivered to the substrate surface whereupon the components are mixed during the polishing process), or one or more of the components can be combined before delivery to the point-of-use, e.g., shortly or immediately before delivery to the point-of-use. Components are combined “immediately before delivery to the point-of-use” if the components are combined about 5 minutes or less prior to being added in mixed form onto the platen, for example, about 4 minutes or less, about 3 minutes or less, about 2 minutes or less, about 1 minute or less, about 45 seconds or less, about 30 seconds or less, about 10 seconds or less prior to being added in mixed form onto the platen, or simultaneously to the delivery of the components at the point-of-use (e.g., the components are combined at a dispenser). Components also are combined “immediately before delivery to the point-of-use” if the components are combined within 5 m of the point-of-use, such as within 1 m of the point-of-use or even within 10 cm of the point-of-use (e.g., within 1 cm of the point-of-use).

When two or more of the components of the polishing composition are combined prior to reaching the point-of-use, the components can be combined in the flow line and delivered to the point-of-use without the use of a mixing device. Alternatively, one or more of the flow lines can lead into a mixing device to facilitate the combination of two or more of the components. Any suitable mixing device can be used. For example, the mixing device can be a nozzle or jet (e.g., a high-pressure nozzle or jet) through which two or more of the components flow. Alternatively, the mixing device can be a container-type mixing device comprising one or more inlets by which two or more components of the polishing slurry are introduced to the mixer, and at least one outlet through which the mixed components exit the mixer to be delivered to the point-of-use, either directly or via other elements of the apparatus (e.g., via one or more flow lines). Furthermore, the mixing device can comprise more than one chamber, each chamber having at least one inlet and at least one outlet, wherein two or more components are combined in each chamber. If a container-type mixing device is used, the mixing device preferably comprises a mixing mechanism to further facilitate the combination of the components. Mixing mechanisms are generally known in the art and include stirrers, blenders, agitators, paddled baffles, gas sparger systems, vibrators, etc.

The polishing composition also can be provided as a concentrate which is intended to be diluted with an appropriate amount of water prior to use. In such an embodiment, the polishing composition concentrate comprises the components of the polishing composition in amounts such that, upon dilution of the concentrate with an appropriate amount of water, each component of the polishing composition will be present in the polishing composition in an amount within the appropriate range recited above for each component. For example, the alpha alumina particles, fumed alumina particles, silica particles, oxidizing agent, optional buffering agent, optional biocide, and/or any other optional additive can each be present in the concentrate in an amount that is about 2 times (e.g., about 3 times, about 4 times, or about 5 times) greater than the concentration recited above for each component so that, when the concentrate is diluted with an equal volume of water (e.g., 2 equal volumes water, 3 equal volumes of water, or 4 equal volumes of water, respectively), each component will be present in the polishing composition in an amount within the ranges set forth above for each component.

The invention further provides a method of chemically-mechanically polishing a substrate comprising: (i) providing a substrate, (ii) providing a polishing pad, (iii) providing a chemical-mechanical polishing composition comprising: (a) alpha alumina particles with a particle size of greater than 250 nm having an average circularity value of at least 0.6, wherein the circularity value is determined using the formula:

$$Circularity = 4 π ( \frac{area of particle cross section}{perimeter of {particle}^{2}} ) ,$$

wherein the area of particle cross section and the perimeter of particle are measured using a binarized electron micrograph, (b) an oxidizing agent, and (c) water, wherein the polishing composition has a pH of about 0 to about 6, (iv) contacting the substrate with the polishing pad and the chemical-mechanical polishing composition, and (v) moving the polishing pad and the chemical-mechanical polishing composition relative to the substrate to abrade at least a portion of the substrate to polish the substrate.

In some embodiments, the method of chemically-mechanically polishing a substrate comprises: (i) providing a substrate, (ii) providing a polishing pad, (iii) providing a chemical-mechanical polishing composition comprising: (a) alpha alumina particles with a particle size of greater than 250 nm having an average circularity value of at least 0.6, wherein the circularity value is determined using the formula:

$$Circularity = 4 π ( \frac{area of particle cross section}{perimeter of {particle}^{2}} ) ,$$

wherein the area of particle cross section and the perimeter of particle are measured using a binarized electron micrograph, (b) alpha alumina particles with a particle size of 250 nm or lower, (c) an oxidizing agent, and (d) water, wherein the polishing composition has a pH of about 0 to about 6, (iv) contacting the substrate with the polishing pad and the chemical-mechanical polishing composition, and (v) moving the polishing pad and the chemical-mechanical polishing composition relative to the substrate to abrade at least a portion of the substrate to polish the substrate.

In some embodiments, the method of chemically-mechanically polishing a substrate comprises: (i) providing a substrate, (ii) providing a polishing pad, (iii) providing a chemical-mechanical polishing composition comprising: (a) alpha alumina particles with a particle size of greater than 250 nm having an average circularity value of at least 0.6, wherein the circularity value is determined using the formula:

$$Circularity = 4 π ( \frac{area of particle cross section}{perimeter of {particle}^{2}} ) ,$$

wherein the area of particle cross section and the perimeter of particle are measured using a binarized electron micrograph, (b) alpha alumina particles with a particle size of 250 nm or lower, (c) silica particles, (d) an oxidizing agent, and (e) water, wherein the polishing composition has a pH of about 0 to about 6, (iv) contacting the substrate with the polishing pad and the chemical-mechanical polishing composition, and (v) moving the polishing pad and the chemical-mechanical polishing composition relative to the substrate to abrade at least a portion of the substrate to polish the substrate.

In some embodiments, the method of chemically-mechanically polishing a substrate comprises: (i) providing a substrate, (ii) providing a polishing pad, (iii) providing a chemical-mechanical polishing composition comprising: (a) alpha alumina particles with a particle size of greater than 250 nm having an average circularity value of at least 0.6, wherein the circularity value is determined using the formula:

$$Circularity = 4 π ( \frac{area of particle cross section}{perimeter of {particle}^{2}} ) ,$$

wherein the area of particle cross section and the perimeter of particle are measured using a binarized electron micrograph, (b) alpha alumina particles with a particle size of 250 nm or lower, (c) fumed alumina particles, (d) silica particles, (e) an oxidizing agent, and (f) water, wherein the polishing composition has a pH of about 0 to about 6, (iv) contacting the substrate with the polishing pad and the chemical-mechanical polishing composition, and (v) moving the polishing pad and the chemical-mechanical polishing composition relative to the substrate to abrade at least a portion of the substrate to polish the substrate.

In some embodiments, the method of chemically-mechanically polishing a substrate comprises: (i) providing a substrate, (ii) providing a polishing pad, (iii) providing a chemical-mechanical polishing composition comprising: (a) alpha alumina particles with a particle size of greater than 250 nm having an average circularity value of at least 0.6, wherein the circularity value is determined using the formula:

$$Circularity = 4 π ( \frac{area of particle cross section}{perimeter of {particle}^{2}} ) ,$$

wherein the area of particle cross section and the perimeter of particle are measured using a binarized electron micrograph, (b) alpha alumina particles with a particle size of 250 nm or lower, (c) a peroxysulfuric acid or a salt thereof, and (d) water, wherein the polishing composition has a pH of about 0 to about 6, (iv) contacting the substrate with the polishing pad and the chemical-mechanical polishing composition, and (v) moving the polishing pad and the chemical-mechanical polishing composition relative to the substrate to abrade at least a portion of the substrate to polish the substrate.

In some embodiments, the method of chemically-mechanically polishing a substrate comprises: (i) providing a substrate, (ii) providing a polishing pad, (iii) providing a chemical-mechanical polishing composition comprising: (a) alpha alumina particles with a particle size of greater than 250 nm having an average circularity value of at least 0.6, wherein the circularity value is determined using the formula:

$$Circularity = 4 π ( \frac{area of particle cross section}{perimeter of {particle}^{2}} ) ,$$

wherein the area of particle cross section and the perimeter of particle are measured using a binarized electron micrograph, (b) alpha alumina particles with a particle size of 250 nm or lower, (c) silica particles, (d) a peroxysulfuric acid or a salt thereof, and (e) water, wherein the polishing composition has a pH of about 0 to about 6, (iv) contacting the substrate with the polishing pad and the chemical-mechanical polishing composition, and (v) moving the polishing pad and the chemical-mechanical polishing composition relative to the substrate to abrade at least a portion of the substrate to polish the substrate.

In some embodiments, the method of chemically-mechanically polishing a substrate comprises: (i) providing a substrate, (ii) providing a polishing pad, (iii) providing a chemical-mechanical polishing composition comprising: (a) alpha alumina particles with a particle size of greater than 250 nm having an average circularity value of at least 0.6, wherein the circularity value is determined using the formula:

$$Circularity = 4 π ( \frac{area of particle cross section}{perimeter of {particle}^{2}} ) ,$$

wherein the area of particle cross section and the perimeter of particle are measured using a binarized electron micrograph, (b) alpha alumina particles with a particle size of 250 nm or lower, (c) fumed alumina particles, (d) silica particles, (e) a peroxysulfuric acid or a salt thereof, and (f) water, wherein the polishing composition has a pH of about 0 to about 6, (iv) contacting the substrate with the polishing pad and the chemical-mechanical polishing composition, and (v) moving the polishing pad and the chemical-mechanical polishing composition relative to the substrate to abrade at least a portion of the substrate to polish the substrate.

The chemical-mechanical polishing composition can be used to polish any suitable substrate and is especially useful for polishing substrates comprising at least one layer (typically a surface layer) comprised of nickel-phosphorus (NiP). In some embodiments, the substrate comprises nickel-phosphorus on a surface of the substrate, and wherein at least a portion of the nickel-phosphorus on a surface of the substrate is abraded to polish the substrate. In certain embodiments, the substrate comprises nickel-phosphorus-coated aluminum. For example, the substrate can be a nickel-phosphorus coated (e.g., a nickel-phosphorus-coated aluminum) hard disk drive (HDD).

In some embodiments, the polishing composition of the invention desirably exhibits low particle defects when polishing a substrate, as determined by suitable techniques. Particle defects on a substrate polished with the inventive polishing composition can be determined by any suitable technique. For example, laser light scattering techniques, such as dark field normal beam composite (DCN) and dark field oblique beam composite (DCO), can be used to determine particle defects on polished substrates. Suitable instrumentation for evaluating particle defectivity is available from, for example, KLA-Tencor (e.g., SURFSCAN™ SPI instruments operating at a 120 nm threshold or at 160 nm threshold).

The chemical-mechanical polishing composition and method of the invention are particularly suited for use in conjunction with a chemical-mechanical polishing apparatus. Typically, the apparatus comprises a platen, which, when in use, is in motion and has a velocity that results from orbital, linear, or circular motion, a polishing pad in contact with the platen and moving with the platen when in motion, and a carrier that holds a substrate to be polished by contacting and moving the substrate relative to the surface of the polishing pad. The polishing of the substrate takes place by the substrate being placed in contact with the polishing pad and the polishing composition of the invention, and then the polishing pad moving relative to the substrate, so as to abrade at least a portion of the substrate to polish the substrate.

A substrate can be polished with the chemical-mechanical polishing composition using any suitable polishing pad (e.g., polishing surface). Suitable polishing pads include, for example, woven and non-woven polishing pads. Moreover, suitable polishing pads can comprise any suitable polymer of varying density, hardness, thickness, compressibility, ability to rebound upon compression, and compression modulus. Suitable polymers include, for example, polyvinylchloride, polyvinylfluoride, nylon, fluorocarbon, polycarbonate, polyester, polyacrylate, polyether, polyethylene, polyamide, polyurethane, polystyrene, polypropylene, coformed products thereof, and mixtures thereof. Soft polyurethane polishing pads are particularly useful in conjunction with the inventive polishing method. Typical pads include but are not limited to SURFIN™ 000, SURFIN™ SSW1, SPM3100 Eminess Technologies), POLITEX™ commercially available from Dow Chemical Company (Newark, DE), POLYPAS™ 27 or Fujibo H7000 commercially available from Fujibo (Osaka, JP), and EPIC™ D100 pads or NEXPLANAR™ E6088 commercially available from Entegris, Inc. (Aurora, IL).

Desirably, the chemical-mechanical polishing apparatus further comprises an in situ polishing endpoint detection system, many of which are known in the art. Techniques for inspecting and monitoring the polishing process by analyzing light or other radiation reflected from a surface of the substrate being polished are known in the art. Such methods are described, for example, in U.S. Pat. Nos. 5,196,353, 5,433,651, 5,609,511. U.S. Pat. Nos. 5,643,046, 5,658,183, 5,730,642, 5,838,447, 5,872,633. U.S. Pat. Nos. 5,893,796, 5,949,927, and 5,964,643. Desirably, the inspection or monitoring of the progress of the polishing process with respect to a substrate being polished enables the determination of the polishing end-point, i.e., the determination of when to terminate the polishing process with respect to a particular substrate.

Aspects, including embodiments, of the invention described herein may be beneficial alone or in combination, with one or more other aspects or embodiments. Without limiting the foregoing description, certain non-limiting embodiments of the disclosure numbered 1-42 are provided below. As will be apparent to those of skill in the art upon reading this disclosure, each of the individually numbered embodiments may be used or combined with any of the preceding or following individually numbered embodiments. This is intended to provide support for all such combinations of embodiments and is not limited to combinations of embodiments explicitly provided below:

### EMBODIMENTS

(1) In embodiment (1) is presented a chemical-mechanical polishing composition comprising:
(a) alpha alumina particles with a particle size of greater than 250 nm having an average circularity value of at least 0.6, wherein the circularity value is determined using the formula:

$$Circularity = 4 π ( \frac{area of particle cross section}{perimeter of {particle}^{2}} ) ,$$

wherein the area of particle cross section and the perimeter of particle are measured using a binarized electron micrograph,
(b) an oxidizing agent, and
(c) water,
wherein the polishing composition has a pH of about 0 to about 6.
(2) In embodiment (2) is presented the polishing composition of embodiment (1), wherein the polishing composition has a pH of about 0 to about 3.
(3) In embodiment (3) is presented the polishing composition of embodiment (1) or embodiment (2), wherein the polishing composition has a pH of about 1 to about 3.
(4) In embodiment (4) is presented the polishing composition of any one of embodiments (1)-(3), wherein the polishing composition comprises about 0.01 wt. % to about 5 wt. % of the alpha alumina particles with a particle size of greater than 250 nm.
(5) In embodiment (5) is presented the polishing composition of any one of embodiments (1)-(4), wherein the polishing composition comprises about 0.1 wt. % to about 2 wt. % of the alpha alumina particles with a particle size of greater than 250 nm.
(6) In embodiment (6) is presented the polishing composition of any one of embodiments (1)-(5), wherein the alpha alumina particles with a particle size of greater than 250 nm have an average particle size of about 300 nm to about 800 nm.
(7) In embodiment (7) is presented the polishing composition of any one of embodiments (1)-(6), wherein the oxidizing agent is hydrogen peroxide, a urea hydrogen peroxide, a peroxysulfuric acid, a peroxyacetic acid, a perboric acid, a salt thereof, or a combination thereof.
(8) In embodiment (8) is presented the polishing composition of any one of embodiments (1)-(7), wherein the polishing composition further comprises silica particles.
(9) In embodiment (9) is presented the polishing composition of embodiment (8), wherein the polishing composition comprises about 0.01 wt. % to about 5 wt. % of the silica particles.
(10) In embodiment (10) is presented the polishing composition of embodiment (8) or embodiment (9), wherein the polishing composition comprises about 0.1 wt. % to about 2 wt. % of the silica particles.
(11) In embodiment (11) is presented the polishing composition of any one of embodiments (1)-(10), wherein the polishing composition further comprises fumed alumina particles.
(12) In embodiment (12) is presented the polishing composition of embodiment (11), wherein the polishing composition comprises about 0.1 wt. % to about 1 wt. % of the fumed alumina particles.
(13) In embodiment (13) is presented the polishing composition of embodiment (11) or embodiment (12), wherein the fumed alumina particles have an average particle size of about 50 nm to about 150 nm.
(14) In embodiment (14) is presented the polishing composition of any one of embodiments (1)-(13), wherein the polishing composition further comprises a surfactant.
(15) In embodiment (15) is presented the polishing composition of embodiment (14), wherein the surfactant is a non-ionic surfactant.
(16) In embodiment (16) is presented the polishing composition of any one of embodiments (1)-(15), wherein the polishing composition further comprises a pH adjusting agent, a buffering agent, or a combination thereof.
(17) In embodiment (17) is presented the polishing composition of any one of embodiments (1)-(16), wherein the polishing composition further comprises a biocide.
(18) In embodiment (18) is presented the polishing composition of any one of embodiments (1)-(17), wherein the alpha alumina particles with a particle size of greater than 250 nm have an average circularity value of 0.6-1.0.
(19) In embodiment (19) is presented the polishing composition of any one of embodiments (1)-(18), wherein the alpha alumina particles with a particle size of greater than 250 nm have an average circularity value of 0.6-0.85.
(20) In embodiment (20) is presented the polishing composition of any one of embodiments (1)-(19), wherein the alpha alumina particles with a particle size of greater than 250 nm have an average circularity value of 0.65-0.8.
(21) In embodiment (21) is presented the is presented a method of chemically-mechanically polishing a substrate comprising:
(i) providing a substrate,
(ii) providing a polishing pad,
(iii) providing a chemical-mechanical polishing composition comprising:
(a) alpha alumina particles with a particle size of greater than 250 nm having an average circularity value of at least 0.6, wherein the circularity value is determined using the formula:

$$Circularity = 4 π ( \frac{area of particle cross section}{perimeter of {particle}^{2}} ) ,$$

wherein the area of particle cross section and the perimeter of particle are measured using a binarized electron micrograph,
(b) an oxidizing agent, and
(c) water,
wherein the polishing composition has a pH of about 0 to about 6,
(iv) contacting the substrate with the polishing pad and the chemical-mechanical polishing composition, and
(v) moving the polishing pad and the chemical-mechanical polishing composition relative to the substrate to abrade at least a portion of the substrate to polish the substrate.
(22) In embodiment (22) is presented the polishing composition of embodiment (21), wherein the polishing composition has a pH of about 0 to about 3.
(23) In embodiment (23) is presented the polishing composition of embodiment (21) or embodiment (22), wherein the polishing composition has a pH of about 1 to about 3.
(24) In embodiment (24) is presented the polishing composition of any one of embodiments (21)-(23), wherein the polishing composition comprises about 0.01 wt. % to about 5 wt. % of the alpha alumina particles with a particle size of greater than 250 nm.
(25) In embodiment (25) is presented the polishing composition of any one of embodiments (21)-(24), wherein the polishing composition comprises about 0.1 wt. % to about 2 wt. % of the alpha alumina particles with a particle size of greater than 250 nm.
(26) In embodiment (26) is presented the polishing composition of any one of embodiments (21)-(25), wherein the alpha alumina particles with a particle size of greater than 250 nm have an average particle size of about 300 nm to about 800 nm.
(27) In embodiment (27) is presented the polishing composition of any one of embodiments (21)-(26), wherein the oxidizing agent is hydrogen peroxide, a urea hydrogen peroxide, a peroxysulfuric acid, a peroxyacetic acid, a perboric acid, a salt thereof, or a combination thereof.
(28) In embodiment (28) is presented the polishing composition of any one of embodiments (21)-(27), wherein the polishing composition further comprises silica particles.
(29) In embodiment (29) is presented the method of embodiment (28), wherein the polishing composition comprises about 0.01 wt. % to about 5 wt. % of the silica particles.
(30) In embodiment (30) is presented the method of embodiment (28) or embodiment (29), wherein the polishing composition comprises about 0.1 wt. % to about 2 wt. % of the silica particles.
(31) In embodiment (31) is presented the method of any one of embodiments (21)-(30), wherein the polishing composition further comprises fumed alumina particles.
(32) In embodiment (32) is presented the method of embodiment (31), wherein the polishing composition comprises about 0.1 wt. % to about 1 wt. % of the fumed alumina particles.
(33) In embodiment (33) is presented the method of embodiment (31) or embodiment (32), wherein the fumed alumina particles have an average particle size of about 50 nm to about 150 nm.
(34) In embodiment (34) is presented the method of any one of embodiments (21)-(33), wherein the polishing composition further comprises a surfactant.
(35) In embodiment (35) is presented the method of embodiments (34), wherein the surfactant is a non-ionic surfactant.
(36) In embodiment (36) is presented the method of any one of embodiments (21)-(35), wherein the polishing composition further comprises a pH adjusting agent, a buffering agent, or a combination thereof.
(37) In embodiment (37) is presented the method of any one of embodiments (21)-(36), wherein the polishing composition further comprises a biocide.
(38) In embodiment (38) is presented the method of any one of embodiments (21)-(37), wherein the alpha alumina particles with a particle size of greater than 250 nm have an average circularity value of 0.6-1.0.
(39) In embodiment (39) is presented the method of any one of embodiments (21)-(38), wherein the alpha alumina particles with a particle size of greater than 250 nm have an average circularity value of 0.6-0.85.
(40) In embodiment (40) is presented the method of any one of embodiments (21)-(39), wherein the alpha alumina particles with a particle size of greater than 250 nm have an average circularity value of 0.65-0.8.
(41) In embodiment (41) is presented the method of any one of embodiments (21)-(40), wherein the substrate comprises nickel-phosphorus on a surface of the substrate, and wherein at least a portion of the nickel-phosphorus on a surface of the substrate is abraded to polish the substrate.
(42) In embodiment (42) is presented the method of any one of embodiments (21)-(41), wherein the substrate comprises nickel-phosphorus-coated aluminum.

### EXAMPLES

These following examples further illustrate the invention but, of course, should not be construed as in any way limiting its scope.

### Example 1

This example demonstrates the properties of alpha alumina particles with a particle size of greater than 250 nm having an average circularity value of at least 0.6 and alpha alumina particles having an average circularity value of less than 0.6.

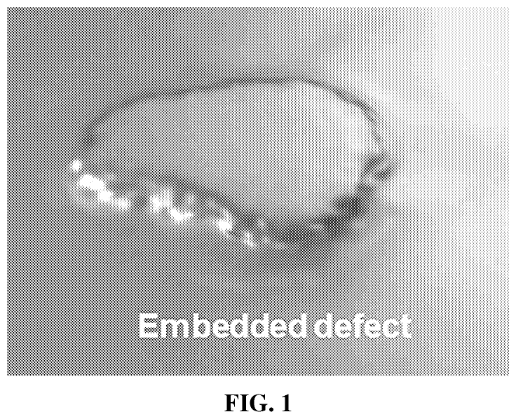

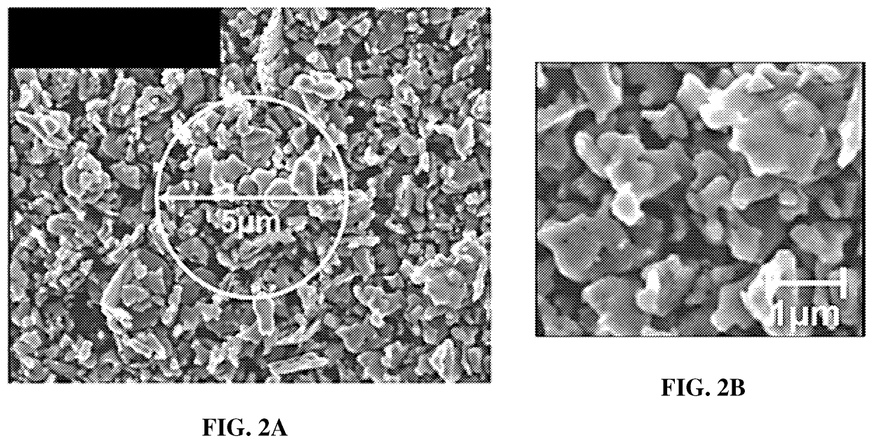

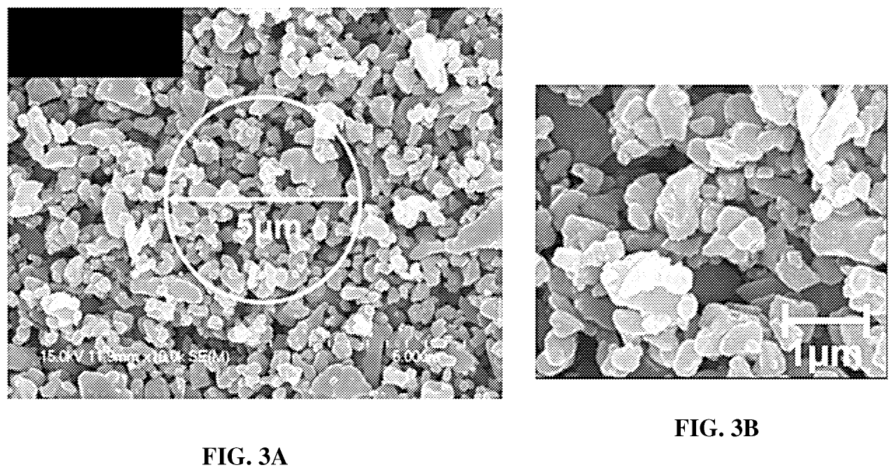

Alpha alumina particles having sharp edges and alpha alumina particles having blunted and smooth surfaces were subjected to scanning electron microscope imaging and the binarized electron micrograph results are set forth in FIGS. 2A, 2B, 3A, and 3B. In particular, FIGS. 2A and 2B are scanning electron microscope images showing alpha alumina particles with sharp edges at display scales of 5 μm (FIG. 2A) and 1 μm (FIG. 2B), and FIGS. 3A and 3B are scanning electron microscope images showing alpha alumina particles with blunted and smooth surfaces at display scales of 5 μm (FIG. 3A) and 1 μm (FIG. 3B).

The circularity of the alpha alumina particles having sharp edges and alpha alumina particles having blunted and smooth surfaces were calculated from representative particle segments (selected near the mean particle size) obtained from the binarized electron micrographs using the following formula:

$$Circularity = 4 π ( \frac{area of particle cross section}{perimeter of {particle}^{2}} ) .$$

The alpha alumina particles having sharp edges, depicted in FIGS. 2A and 2B, had a circularity of 0.42, whereas the alpha alumina particles having blunted and smooth surfaces, depicted in FIGS. 3A and 3B, had a circularity of 0.71. The higher circularity value of the alpha alumina particles having blunted and smooth surfaces indicates that they are rounder (i.e., more likely to slide over the substrate surface without embedding/penetrating into the substrate) than the alpha alumina particles having sharp edges. In other words, these results show that the circularity value quantifies how round the particle is, where a higher circularity value corresponds to a rounder particle, as evidenced by scanning electron microscope images 2A, 2B, 3A, and 3B.

### Example 2

This example demonstrates the effect of alpha alumina particles with a particle size of greater than 250 nm having an average circularity value of at least 0.6 on nickel-phosphorus (NiP) polishing performance.

Polishing Compositions 2A and 2B, used in this example, were prepared by combining (A) alpha alumina particles with a particle size of greater than 250 nm (average particle size of approximately 500 nm) having sharp edges with a circularity of 0.42 [XX wt. %] or (B) alpha alumina particles with a particle size of greater than 250 nm (average particle size of approximately 500 nm) having blunted and smooth surfaces with a circularity of 0.71 [1.40 wt. %], as described in Example 1, with (i) alpha alumina particles having a particle size of less than 250 nm (average particle size of approximately 200 nm) [0.20 wt. %], (ii) fumed alumina particles having an average particle size of 120 nm [0.40 wt. %], (iii) glycine [0.85 wt. %], (iv), anionic silica with an average particle size of 100 nm [1.40 wt. %], (v) methylisothiazolinone [8 ppm], (vi) ethylene oxide/propylene oxide copolymer [0.01 wt. %], and (vii) sodium persulfate [4.20 wt. %], in an aqueous solution and the pH was adjusted to 2.4 with nitric acid.

Nickel-phosphorus (NiP) coated aluminum memory disks were polished under identical conditions with Polishing Compositions 2A and 2B on a Speedfam™ 16B double side polisher (Konegawa, Japan). Twelve (12) disks were polished in each run at 0.84 PSI (46 Kg) downforce using a Ceiba CR200 pad commercially available from Ceiba Technologies to a target NiP removal of 150±10 mg. Speedfam polishing parameters were as follows: Upper platen speed=6 rpm, Lower platen speed=18 rpm, Slurry flow rate=300 mL/min.

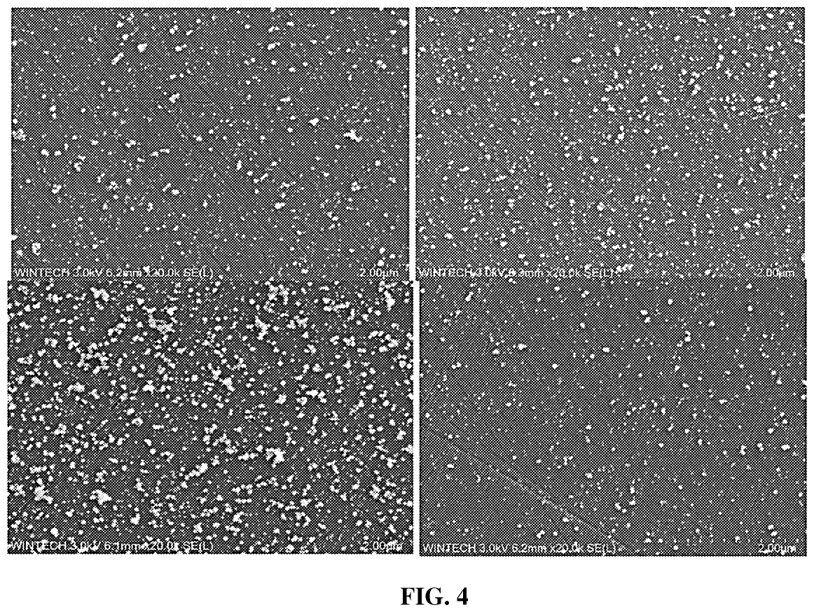

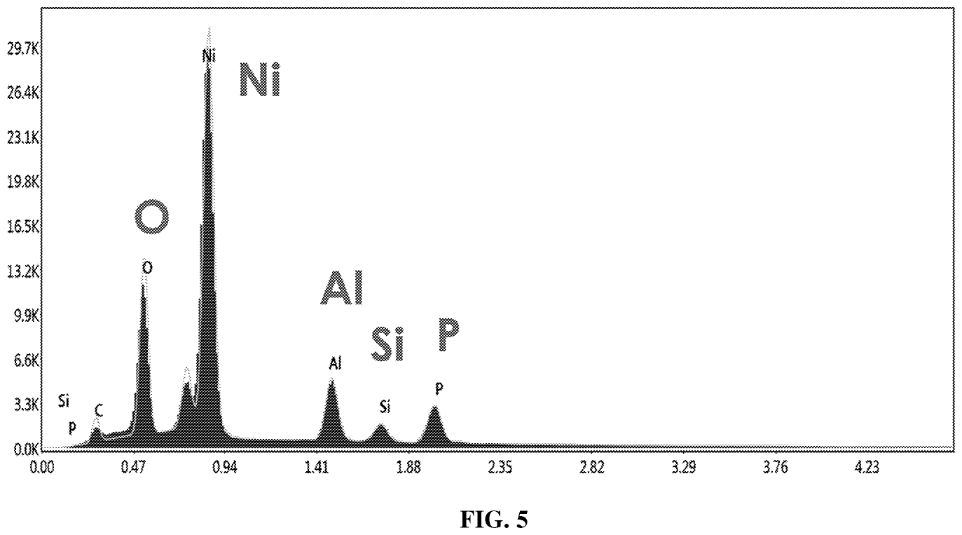

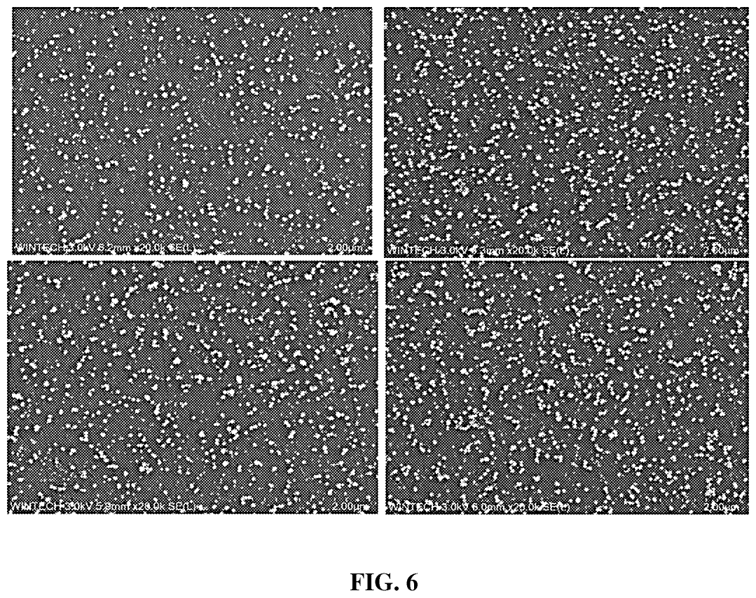

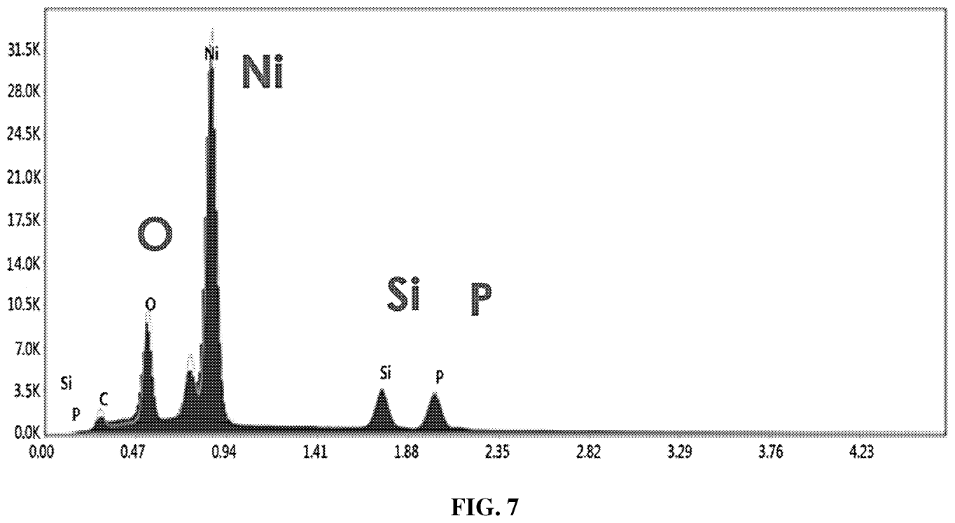

The polished NiP-coated aluminum memory disks were collected without a cleaning step and subjected to scanning electron microscope (SEM) analysis at four positions per disk with a magnification of 20 k and energy-dispersive x-ray (EDX) analysis. The scanning electron microscope (SEM) results for Polishing Compositions 2A and 2B are set forth in FIGS. 4 and 6, respectively. The energy-dispersive x-ray (EDX) results for Polishing Compositions 2A and 2B are set forth in FIGS. 5 and 7, respectively.

As is apparent from the results set forth in FIGS. 4 and 6, despite 20 k magnification, the surfaces of the polished NiP-coated aluminum memory disks showed mostly silica particles with no clear indication of alumina particles when analyzed by a scanning electron microscope (SEM). However, energy-dispersive x-ray (EDX) analysis of the polished NiP-coated aluminum memory disk showed that Polishing Composition 2A, containing alpha alumina particles with a particle size of greater than 250 nm (average particle size of approximately 500 nm) having sharp edges with a circularity of 0.42, resulted in alumina residue remaining on the disk surface. See FIG. 6. In contrast, energy-dispersive x-ray (EDX) analysis of the polished NiP-coated aluminum memory disk showed that Polishing Composition 2B containing alpha alumina particles with a particle size of greater than 250 nm (average particle size of approximately 500 nm) having blunted and smooth surfaces with a circularity of 0.71, resulted in no alumina residue remaining on the disk surface. See FIG. 7.

These results demonstrate that alpha alumina particles having blunted and smooth surfaces with a circularity of greater than 0.6 produced fewer embedded defects than the alpha alumina particles having sharp edges with a circularity of less than 0.6.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A chemical-mechanical polishing composition comprising:
(a) alpha alumina particles with a particle size of greater than 250 nm having an average circularity value of at least 0.6, wherein the circularity value is determined using the formula:
$$Circularity = 4 π ( \frac{area of particle cross section}{perimeter of {particle}^{2}} ) ,$$
wherein the area of particle cross section and the perimeter of particle are measured using a binarized electron micrograph,
(b) an oxidizing agent, and
(c) water,
wherein the polishing composition has a pH of about 0 to about 6.

2. The polishing composition of claim 1, wherein the polishing composition has a pH of about 1 to about 3.

3. The polishing composition of claim 1, wherein the polishing composition comprises about 0.01 wt. % to about 5 wt. % of the alpha alumina particles with a particle size of greater than 250 nm.

4. The polishing composition of claim 1, wherein the alpha alumina particles with a particle size of greater than 250 nm have an average particle size of about 300 nm to about 800 nm.

5. The polishing composition of claim 1, wherein the polishing composition further comprises about 0.01 wt. % to about 5 wt. % of silica particles.

6. The polishing composition of claim 1, wherein the polishing composition further comprises about 0.1 wt. % to about 1 wt. % of fumed alumina particles, wherein the fumed alumina particles have an average particle size of about 50 nm to about 150 nm.

7. The polishing composition of claim 1, wherein the polishing composition further comprises a surfactant.

8. The polishing composition of claim 4, wherein the alpha alumina particles with a particle size of greater than 250 nm have an average circularity value of 0.6-1.0.

9. The polishing composition of claim 4, wherein the alpha alumina particles with a particle size of greater than 250 nm have an average circularity value of 0.65-0.8.

10. A method of chemically-mechanically polishing a substrate comprising:
(i) providing a substrate,
(ii) providing a polishing pad,
(iii) providing a chemical-mechanical polishing composition comprising:
(a) alpha alumina particles with a particle size of greater than 250 nm having an average circularity value of at least 0.6, wherein the circularity value is determined using the formula:
$$Circularity = 4 π ( \frac{area of particle cross section}{perimeter of {particle}^{2}} ) ,$$
wherein the area of particle cross section and the perimeter of particle are measured using a binarized electron micrograph,
(b) an oxidizing agent, and
(c) water,
wherein the polishing composition has a pH of about 0 to about 6,
(iv) contacting the substrate with the polishing pad and the chemical-mechanical polishing composition, and
(v) moving the polishing pad and the chemical-mechanical polishing composition relative to the substrate to abrade at least a portion of the substrate to polish the substrate.

11. The method of claim 10, wherein the polishing composition has a pH of about 1 to about 3.

12. The method of claim 10, wherein the polishing composition comprises about 0.01 wt. % to about 5 wt. % of the alpha alumina particles with a particle size of greater than 250 nm.

13. The method of claim 10, wherein the alpha alumina particles with a particle size of greater than 250 nm have an average particle size of about 300 nm to about 800 nm.

14. The method of claim 10, wherein the polishing composition further comprises about 0.01 wt. % to about 5 wt. % of silica particles.

15. The method of claim 10, wherein the polishing composition further comprises about 0.1 wt. % to about 1 wt. % of fumed alumina particles.

16. The method of claim 15, wherein the fumed alumina particles have an average particle size of about 50 nm to about 150 nm.

17. The method of claim 10, wherein the polishing composition further comprises a surfactant.

18. The method of claim 10, wherein the alpha alumina particles with a particle size of greater than 250 nm have an average circularity value of 0.65-0.8.

19. The method of claim 10, wherein the substrate comprises nickel-phosphorus on a surface of the substrate, and wherein at least a portion of the nickel-phosphorus on a surface of the substrate is abraded to polish the substrate.

20. The method of claim 19, wherein the substrate comprises nickel-phosphorus-coated aluminum.
